(19) United States
(12) Patent Application Publication
(10) Pub. No.: US 2014/0038005 A1
(43) Pub. Date: Feb. 6, 2014

(54) SEALED CELL AND METHOD FOR MANUFACTURING SAME

(71) Applicants: Kenji Yamato, Osaka (JP); Syuichi Yamashita, Tokushima (JP); Yuma Yamaguchi, Tokushima (JP)

(72) Inventors: Kenji Yamato, Osaka (JP); Syuichi Yamashita, Tokushima (JP); Yuma Yamaguchi, Tokushima (JP)

(73) Assignee: SANYO ELECTRIC CO., LTD., Moriguchi-shi, Osaka (JP)

(21) Appl. No.: 14/111,134

(22) PCT Filed: Apr. 25, 2012
(86) PCT No.: PCT/JP2012/061073

§ 371 Date: Oct. 10, 2013

(30) Foreign Application Priority Data
Apr. 28, 2011 (JP) 2011-101481

(51) Int. Cl. H01M 2/12

(52) U.S. Cl. CPC H01M 2/1235
USPC 429/57; 29/623.2

(57) ABSTRACT

An object of the present invention is to manufacture a sealed cell having a highly conductive sealing body with a safety valve at high productivity. In order to accomplish above object, the present invention espouses a method of manufacturing a sealed cell including: preparing a terminal cap and a safety valve, the terminal cap including an external terminal projecting toward the outside of the cell, and a flange, and the safety valve including a conductive contact portion projecting toward the inside of the cell, and a peripheral portion and having an outer periphery bent toward the outside of the cell so as to form a bent portion; temporarily fixing the safety valve and the terminal cap together at the bent portion after coupling the safety valve and the terminal cap to each other; and conductively adhering the flange and the peripheral portion to each other near the bent portion.

### TECHNICAL FIELD

The present invention relates to a sealed cell, and more particularly, to a sealed cell having a sealing body with a safety valve.

### BACKGROUND ART

Non-aqueous electrolyte secondary cells have been widely used as power sources of mobile devices, electric tools, etc. because of their high energy density and high capacity.

Such a non-aqueous electrolyte secondary cell contains a flammable organic solvent, and is therefore required to ensure safety. For this reason, the sealing body for sealing the cell is equipped with a current breaking mechanism, which operates when the cell internal pressure increases (see, for example, Patent Document 1).

The technique of Patent Document 1 will now be described with reference to FIG. 4. FIG. 4 is a partially enlarged sectional view showing the sealed cell of Patent Document 1. As shown in FIG. 4, the cell includes an outer can 20 accommodating an electrode assembly 40 and a non-aqueous electrolyte, and a sealing body 10 secured by caulking to the opening of the outer can 20 with an insulation gasket 30 interposed therebetween. The sealing body 10 includes a terminal cap 5, a safety valve 3 disposed on the inner side of the cell than the terminal cap, a terminal plate 1 disposed on the inner side of the cell than the safety valve, and insulating plate 2 insulating between the safety valve 3 and terminal plate 1. In order for the terminal cap 5 and the safety valve 3 to be in conductive contact with each other, the terminal cap 5 has counterbored holes 5d, whereas the safety valve 3 has pin-shaped projections 3d. The projections 3d are inserted into the counterbored holes 5d, rivet-fixed, and welded. Either the positive or negative electrode of the electrode assembly 40 is connected to the terminal plate 1 via an electrode tab 8.

The operation of the current breaking mechanism of the sealed cell will now be described as follows. The safety valve 3 has a recess (conductive contact portion) 3a projecting toward the inside of the cell. When the cell internal pressure increases, the conductive contact portion 3a is expanded toward the outside of the cell. If the cell internal pressure continues to increase, the terminal plate 1 connected to the conductive contact portion 3a of the safety valve 3 breaks, thereby blocking the current supply from the electrode assembly 40 to the terminal cap 5.

In such a current breaking mechanism, the safety valve is required to be made of a deformable material so that the above-described operation can be performed smoothly, whereas the terminal cap is required to be made of a strong material because it is exposed to the external environment. To achieve these requirements, the safety valve is made of a flexible aluminum-based material, whereas the terminal cap is made of a rigid iron-based material. These materials, however, greatly differ in melting point and electrical characteristics from each other, and are consequently difficult to be welded properly to each other (to reduce the resistance between them). To overcome this problem, in Patent Document 1, proper welding is performed by mainly melting the terminal cap.

In the technique of Patent Document 1, however, preparing the sealing body involves forming and aligning the pin-shaped projections and the counterbored holes, and then rivet-fixing and welding them to each other, which decreases the production efficiency.

Patent Documents 2 to 4, on the other hand, suggest techniques of ensuring conduction by welding the components of the sealing body to each other. These techniques, however, require securing some of the components together by caulking or preparing additional components for welding. This causes an increase in the volume of the sealing body and in the man-hours to produce it, thereby hindering productivity improvement and cell capacity increase.

### CITATION LIST

### Patent Documents

Patent Document 1: Japanese Unexamined Patent Publication No. 2010-86782
Patent Document 2: Japanese Unexamined Patent Publication No. 2009-193862
Patent Document 3: Japanese Unexamined Patent Publication No. 2006-351512
Patent Document 4: Japanese Unexamined Patent Publication No. 2004-303571

### SUMMARY OF THE INVENTION

### Problems to be Solved by the Invention

In order to solve the above-described problems, the present invention is directed to provide a method of manufacturing, at high productivity, a sealed cell having a highly conductive and space-saving sealing body with a safety valve.

### Means of Solving the Problems

In order to solve the above-described problems, a first aspect of a method of manufacturing a sealed cell according to the present invention has the following configuration.

The method of manufacturing a sealed cell having a bottomed cylindrical outer can and a sealing body secured by caulking to the opening of the outer can so as to seal the opening includes the steps of: preparing following components: a terminal cap including an external terminal projecting toward the outside of the cell, and a flange located at the periphery of the external terminal, and a safety valve including a conductive contact portion projecting toward the inside of the cell, and a peripheral portion located at the periphery of the conductive contact portion and having an outer periphery bent toward the outside of the cell so as to form a bent portion; temporarily fixing the safety valve and the terminal cap together at the bent portion after coupling the safety valve and the terminal cap to each other; and conductively adhering the bent portion and the peripheral portion to each other.

In order to solve the above-described problems, a second aspect of the method of manufacturing a sealed cell according to the present invention has the following configuration.

The method of manufacturing a sealed cell having a bottomed cylindrical outer can and a sealing body secured by caulking to the opening of the outer can so as to seal the opening includes the steps of: preparing following components: a terminal cap including an external terminal projecting toward the outside of the cell, and a flange located at the periphery of the external terminal, and a safety valve having a larger diameter than the terminal cap and including a conductive contact portion projecting toward the inside of the cell, and a peripheral portion located at the periphery of the conductive contact portion; temporarily fixing the safety valve and the terminal cap together by bending that part of the peripheral portion which is located outside the periphery of the flange toward the terminal cap after coupling the safety valve and the terminal cap to each other; and conductively adhering the flange and the peripheral portion to each other near the bent portion.

In the above-described methods, the safety valve and the terminal cap are temporarily fixed together at the bent portion formed by bending the part of the peripheral portion of the safety valve which is located outside the periphery of the flange of the terminal cap toward the terminal cap after coupling the safety valve and the terminal cap to each other. With these methods, productivity can be higher than in the case of fixing the safety valve and the terminal cap together with rivets, and the sealing body can be smaller in volume than in the case of securing the safety valve by caulking to the terminal cap.

Furthermore, conductively adhering the flange and the peripheral portion to each other near the bent portion can improve the conductivity (reduce the resistance) between them.

With the above-described advantageous effects, a sealed cell having a highly conductive and space saving sealing body with a safety valve can be manufactured at high productivity.

After the step of temporary fixation, the bent portion may be pressed from outside to reinforce the temporarily fixed portion.

The conductive adhesion can be achieved by welding or using a conductive adhesive agent. Examples of the welding include high-energy beam welding with a laser beam or electron beam, ultrasonic welding, and soldering. The most preferable of these welding techniques is laser welding. The conductive adhesive agent can be of a well-known type such as a conductive filler dispersed in a binder. It is preferable that the binder be an epoxy-based resin, and that the conductive filler be a metal powder such as silver powder, nickel powder, gold plated powder, or palladium powder, or carbon powder.

In the case of laser welding, a laser beam can be applied mainly to either the flange or the peripheral portion depending on which is made of a material having a higher melting point. This allows proper welding while suppressing evaporation.

The safety valve is generally made of a deformable aluminum-based material (pure aluminum or an aluminum alloy), whereas the terminal cap is generally made of an iron-based material having a certain strength (iron or an iron alloy). In the case of welding them, it is preferable to apply a laser beam mainly to the terminal cap made of a material having a higher melting point.

When welding is applied to the entire boundary which is between the flange and the peripheral portion, and is near the bent portion (the outer periphery of the bent portion), no gap is formed therebetween. This eliminates the occurrence of liquid leakage through a gap, for example, at an increase in the cell internal pressure.

In order to suppress an increase in the volume of the sealing body and to facilitate welding by applying a laser beam mainly to the terminal cap material, it is preferable that the outer periphery of the peripheral portion be disposed on the inner side of the cell than the outer side surface of the flange.

A sealed cell according to the present invention, which solves the above-described problems, includes a bottomed cylindrical outer can and a sealing body secured by caulking to the opening of the outer can, wherein the sealing body comprises: a terminal cap including: an external terminal projecting toward the outside of the cell, and a flange located at the periphery of the external terminal; and a safety valve having a larger diameter than the terminal cap and including: a conductive contact portion located on the inner side of the cell than the terminal cap, and projecting toward the inside of the cell, and a peripheral portion located at the periphery of the conductive contact portion, wherein an edge of the peripheral portion of the safety valve is bent toward the flange of the terminal cap so as to form a conductively adhered portion at the boundary between the peripheral portion and the flange, the boundary being near the edge bent.

### Advantageous Effects of the Invention

The present invention provides a highly conductive and space-saving sealing body with a safety valve capable of being manufactured at high productivity, allowing a sealed cell including this sealing body to improve the current extraction efficiency, productivity, and volume energy density.

### BRIEF DESCRIPTION OF DRAWINGS

FIG. 1 is a partially enlarged sectional view of a sealed cell according to the present invention.

FIG. 2 shows a sealing body used for the sealed cell according to the present invention.

FIGS. 3(a) to 3(d) show processes of welding the terminal cap and the safety valve to each other in the sealed cell according to the present invention.

FIG. 4 is a partially enlarged sectional view of the sealed cell according to Patent Document 1.

### DESCRIPTION OF EMBODIMENT

### First Embodiment

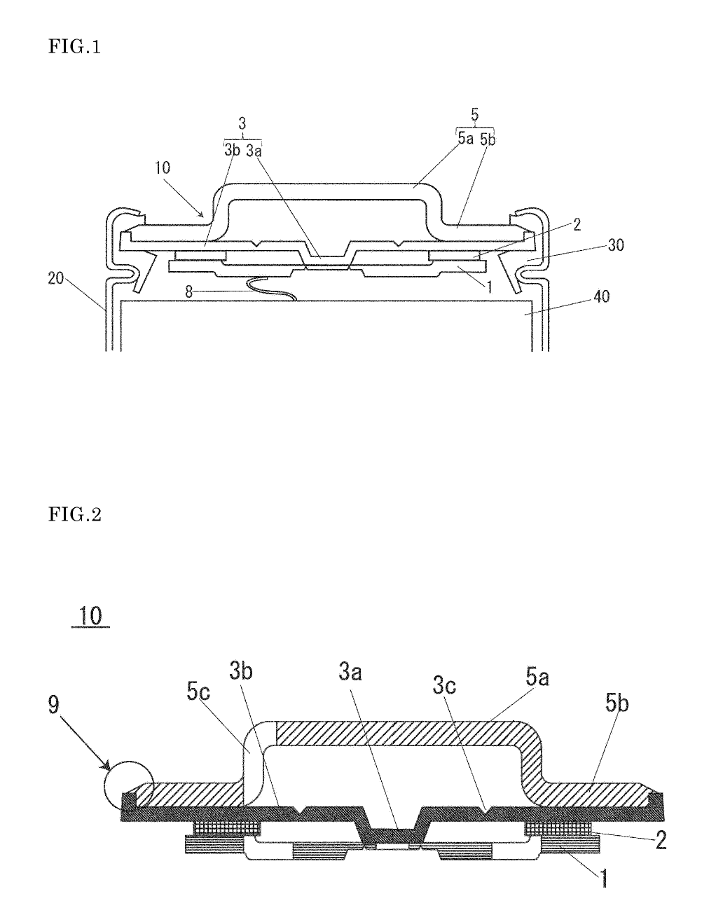

As an embodiment of the present invention, a lithium-ion secondary cell will now be described in detail as follows with reference to the drawings. FIG. 1 is a partially enlarged sectional view of a sealed cell of the present embodiment, and FIG. 2 shows a sealing body used for the sealed cell of the present invention.

As shown in FIG. 1, the sealed cell of the present embodiment includes an outer can 20 accommodating an electrode assembly 40 and a non-aqueous electrolyte, and a sealing body 10 secured by caulking to the opening of the outer can 20 with an insulation gasket 30 interposed therebetween.

As shown in FIGS. 1 and 2, the sealing body 10 used for the sealed cell of the present embodiment includes a terminal plate 1 electrically connected to either the positive or negative electrode via an electrode tab 8; a terminal cap 5 having an external terminal 5a projecting toward the outside of the cell; a safety valve 3 disposed between the terminal plate 1 and the terminal cap 5, the safety valve 3 deforming with an increase in the cell internal pressure, thereby interrupting the electric connection between the terminal plate 1 and the terminal cap 5; and an insulating member 2 preventing the electric contact between the safety valve 3 and the terminal plate 1 when the safety valve 3 blocks the current. Either the positive or negative electrode of the electrode assembly 40 is connected to the terminal plate 1 via the electrode tab 8.

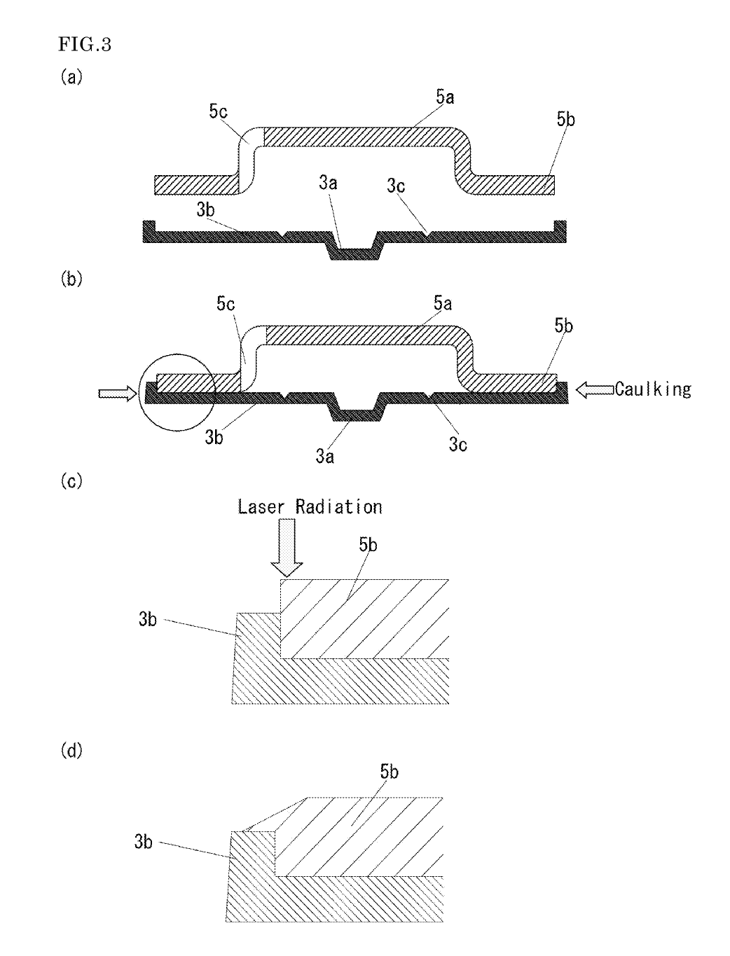

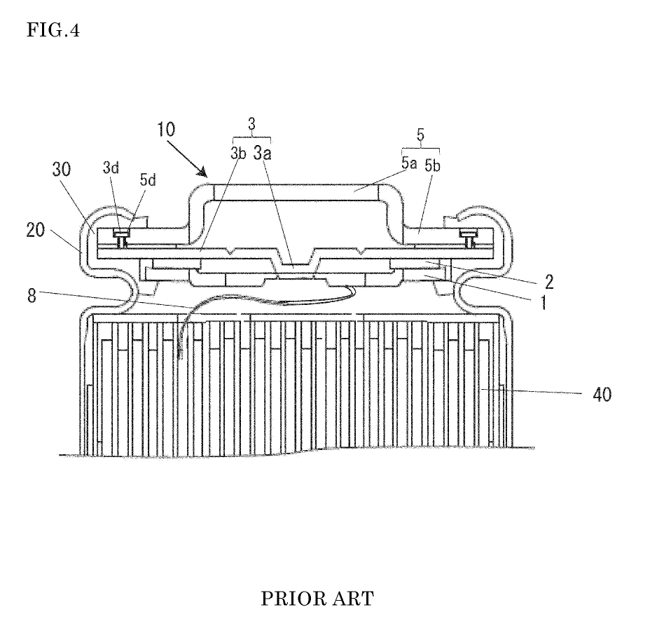

As shown in FIGS. 2, 3(a), and 3(b), the safety valve 3 has a larger diameter than the terminal cap 5, and has a peripheral portion 3b bent toward the flange 5b of the terminal cap 5. The vicinity of the bent portion is laser welded to form a conductively adhered portion 9. The outer periphery of the peripheral portion 3b is disposed on the inner side of the cell than the outer side surface of the flange 5b.

As shown in FIGS. 2, 3(a), and 3(b), the external terminal 5a of the terminal cap 5 has a venting hole 5c for releasing gas from the inside to the outside of the cell.

The following is a description of a method of manufacturing the lithium-ion secondary cell having the above described configuration.

Preparation of the Positive Electrode

First, a positive electrode active material made of lithium cobalt composite oxide (LiCoO₂), a carbon-based conductive agent such as artificial graphite, and a binder made of polyvinylidene fluoride (PVDF) are weighed in a mass ratio of 85.5:9.5:5. The mixture is mixed with an organic solvent of N-methyl-2-pyrrolidone, thereby preparing a positive electrode active material slurry.

Next, the slurry is applied in uniform thickness to both sides of a positive electrode core body made of aluminum foil (thickness: 20 μm) using, for example, a die coater or a doctor blade.

The resultant electrode plate is put in a dryer to remove the organic solvent, thereby preparing a dry electrode plate. This dry electrode plate is rolled by a roll press machine, and cut in size. Next, a positive electrode collector tab made of aluminum foil is ultrasonic-welded to the electrode plate, thereby completing a positive electrode plate.

Besides the above-mentioned lithium cobalt composite oxide, other acceptable examples of the positive electrode active material used for the lithium-ion secondary cell of the present embodiment include lithium-containing transition metal composite oxides such as lithium nickel composite oxide (LiNiO₂), lithium manganese composite oxide (LiMn₂O₄), and other oxides in which a part of transition metal contained in these oxides has been replaced with a different element; and lithium iron phosphate (LiFePO₄). These oxides may be used alone or in combination of two or more thereof.

Preparation of the Negative Electrode

First, a negative electrode active material made of graphite particles; a binder made of styrene-butadiene rubber; and a thickener made of carboxymethylcellulose are mixed in a mass ratio of 100:3:2. The mixture is mixed with an appropriate amount of water, thereby preparing a negative electrode active material slurry.

Next, the slurry is applied in uniform thickness to both sides of a negative electrode core body made of copper foil (thickness; 15 μm) using, for example, a die coater or a doctor blade.

The resultant electrode plate is put in a dryer to remove water, thereby preparing a dry electrode plate. This dry electrode plate is rolled by a roll press machine, and cut in size. Next, a negative electrode collector tab made of copper foil is ultrasonic-welded to the electrode plate, thereby completing a negative electrode plate.

The negative electrode material used for the lithium-ion secondary cell of the present embodiment can be at least one selected from a group consisting of carbonaceous materials such as natural graphite, artificial graphite, carbon black, coke, glassy carbon, carbon fiber, and sintered bodies thereof; silicon, a silicon alloy, lithium, a lithium alloy, and a metal oxide capable of absorbing and desorbing lithium.

Preparation of the Electrode Assembly

The positive and negative electrodes prepared as above are wound together with a separator made of microporous polyethylene film by a winder, and an insulating winding-end tape is applied so as to complete a wound electrode assembly.

Preparation of the Sealing Body

Step of Preparation

The terminal cap 5 and the safety valve 3 are prepared by a well-known method such as plastic working. The terminal cap 5 has the external terminal 5a projecting toward the outside of the cell, a flange 5b located at the periphery of the external terminal 5a, and the venting hole 5c perforated at the shoulder of the external terminal 5a. The safety valve 3 includes the conductive contact portion 3a projecting toward the inside of the cell, the peripheral portion 3b located at the periphery of the conductive contact portion 3a, and a notch 3c formed on the peripheral portion 3b in such a manner as to surround the conductive contact portion 3a. The safety valve 3 has a larger diameter than the terminal cap 5, and the outer periphery of the peripheral portion 3b of the safety valve 3 is bent in the direction opposite to the direction that the conductive contact portion 3a projects. The terminal cap can be made, for example, of nickel-plated iron plate, whereas the safety valve can be made, for example, of aluminum plate.

Step of Temporary Fixation

After the step of preparation, the terminal cap 5 is placed on the upper surface of the safety valve 3, and the flange 5b of the terminal cap 5 is fitted into the bent portion of the peripheral portion 3b of the safety valve 3 and is temporarily fixed (see FIG. 3(a)).

Next, a press mold is used to press the safety valve 3 and the terminal cap 5 from the right and left directions so as to secure them together by caulking, thereby reinforcing the temporary fixation (see FIG. 3(b)).

Alternatively, the outer periphery of the peripheral portion 3b of the safety valve 3 may be bent after the safety valve 3 is aligned with the terminal cap 5.

Step of Conductive Adhesion

Laser radiation is applied to that part of the terminal cap material which is near the portion secured by caulking (see FIG. 3(c)), thereby welding (conductively adhering) the flange 5b and the peripheral portion 3b to each other (see FIG. 3(d)). It is preferable that this laser welding be applied to the entire periphery of the portion secured by caulking.

Instead of laser welding, a conductive adhesive agent may be used so as to conductively adhere the terminal cap 5 and the safety valve 3 to each other near the portion secured by caulking.

Next, the terminal plate 1 made of aluminum is welded to the lower surface of the safety valve 3 with the insulating plate 2 made of a resin interposed therebetween, thereby completing the sealing body 10 (see FIG. 2).

Preparation of the Electrolytic Solution

An electrolytic solution is prepared by dissolving 1.0 M (mol/L) of LiPF₆ as an electrolyte salt in a non-aqueous solvent containing ethylene carbonate (EC), propylene carbonate (PC), and diethyl carbonate (DEC) in a volume ratio of 1:1:8 (under the conditions of 25° C. and 1 atm).

The non-aqueous solvent used for the lithium-ion secondary cell of the present embodiment is not limited to the above-mentioned combination, and can alternatively be a combination of a high dielectric solvent having high solubility of a lithium salt and a low viscosity solvent. Examples of the high dielectric solvent include ethylene carbonate, propylene carbonate, butylene carbonate, and γ-butyrolactone. Examples of the low viscosity solvent include diethyl carbonate, dimethyl carbonate, ethyl methyl carbonate, 1,2-dimethoxyethane, tetrahydrofuran, anisole, 1,4-dioxane, 4-methyl-2-pentanone, cyclohexanone, acetonitrile, propionitrile, dimethylformamide, sulfolane, methyl formate, ethyl formate, methyl acetate, ethyl acetate, propyl acetate, and ethyl propionate. It is alternatively possible to use a mixture solvent of two or more kinds of the high dielectric solvent and two or more kinds of the low viscosity solvent. As the electrolyte salt, LiN(C₂F₅SO₂)₂, LiN(CF₃SO₂)₂, LiClO₄, or LiBF₄ can be used alone or in combination of two or more thereof, beside LiPF₆. In order to enhance the effects of the safety valve, it is also possible to add to the electrolytic solution an aromatic compound such as cyclohexylbenzene or tert-amyl benzene.

Assembling of the Cell

A positive electrode current collector contained in the electrode assembly and the bottom of the cylindrical rectangular outer can are welded to each other; the electrolytic solution is poured into the outer can; the terminal plate of the sealing body and a negative electrode current collector are electrically connected to each other via the electrode tab 8; and the opening of the outer can is secured by caulking and sealed via the gasket, thereby completing the cell of the present embodiment.

### Example 1

Cells of Example 1 having a height of 65 mm and a diameter of 18 mm were manufactured in the same manner as in the above embodiment.

### Comparative Example 1

Cells of Comparative Example 1 were prepared in the same manner as in the embodiment except that the sealing body was made according to the technique of Patent Document 1. In these cells, three pin-shaped projections and three counterbored holes were formed. The counterbored holes each had a large diameter of 1.4 mm and a small diameter of 1.0 mm. The pin-shaped projections had a diameter of 0.9 mm and a height of 0.5 mm.

Productivity Test

The productivity in manufacturing the cells of Example 1 and the cells of Comparative Example 1 were evaluated by measuring the time required for aligning the terminal cap and the safety valve with each other in the attachment process. The measurement results indicate that the required time is twice as long in Comparative Example 1 as in Example 1.

The reason for this result is assumed to be that Comparative Example 1 requires aligning the pin-shaped projections and the counterbored holes with each other, but Example 1 does not.

Liquid Leakage Test

First, 100 cells of Example 1 and 100 cells of Comparative Example 1 were charged for 13 hours in a room-temperature (25° C.) atmosphere at a constant current of 0.1 It (125 mA). The presence or absence of liquid leakage on the safety valve was visually checked. As a result, no liquid leakage was observed in the cells of Example 1, whereas three of the 100 cells had liquid leakage in Comparative

### Example 1

The reason for this result is assumed as follows. In Example 1, the safety valve and the terminal cap are welded to each other throughout the outer periphery, leaving no gap therebetween. In Comparative Example 1, on the other hand, the safety valve and the terminal cap are welded to each other only between the pin-shaped projections and the counterbored holes, leaving gap on the outer periphery.

Welding Reliability Test

The cells of Example 1 and the cells of Comparative Example 1 were charged at a constant current of 1 It (1250 mA) until the voltage reached 4.2 V, and then at a constant voltage of 4.2 V until the current reached 0.02 It (25 mA). After this, these cells were placed in a constant temperature chamber in which the temperature changed from −30° C. to 70° C. in 0.5 hours, and were subjected to 400 cycles when a temperature change from −30° C. to 70° C. and then back to −30° C. is defined as one cycle. The resistance between the safety valve and the terminal cap was measured before and after the test using AC Milliohm High Tester (manufactured by Hioki E.E. Corporation). As a result, the cells of Example 1 and the cells of Comparative Example 1 had nearly the same resistance rise difference (the difference between before and after the test) of 1 mΩ or less.

The reason for this result is assumed as follows. In both Example 1 and Comparative Example 1, the safety valve and the terminal cap were fixed together firmly by being welded to each other, so that their conductive contact can be kept substantially constant regardless of temperature changes or other causes.

The results of these tests indicate that the present invention provides, at high productivity, a sealed cell having a highly conductive and liquid leakage-proof sealing body with a safety valve.

### INDUSTRIAL APPLICABILITY

As described above, according to the present invention, a highly conductive sealing body with a safety valve can be provided at high productivity, and hence, a sealed cell including this sealing body can have a high current extraction efficiency and be manufactured at low cost. Thus, the present invention is highly industrially applicable.

### REFERENCE MARKS IN THE DRAWINGS

1 terminal plate
2 insulating plate
3 safety valve
3a conductive contact portion
3b peripheral portion
3c notch
5 terminal cap
5a external terminal
5b flange
5c venting hole
8 electrode tab
9 conductively adhered portion
10 sealing body
20 outer can
30 insulation gasket
40 electrode assembly

1-8. (canceled)

9. A method of manufacturing a sealed cell including a bottomed cylindrical outer can and a sealing body secured by caulking to an opening of the outer can so as to seal the opening, the method comprising the steps of:
preparing following components:
a terminal cap including an external terminal projecting toward an outside of the cell, and a flange located at a periphery of the external terminal, and
a safety valve including a conductive contact portion projecting toward an inside of the cell, and a peripheral portion located at a periphery of the conductive contact portion and having an outer periphery bent toward the outside of the cell so as to form a bent portion;
temporarily fixing the safety valve and the terminal cap together at the bent portion after coupling the safety valve and the terminal cap to each other; and
conductively adhering the flange and the peripheral portion to each other near the bent portion.

10. A method of manufacturing a sealed cell including a bottomed cylindrical outer can and a sealing body secured by caulking to an opening of the outer can so as to seal the opening, the method comprising the steps of:
preparing following components:
a terminal cap including an external terminal projecting toward an outside of the cell, and a flange located at a periphery of the external terminal, and
a safety valve having a larger diameter than the terminal cap and including a conductive contact portion projecting toward an inside of the cell, and a peripheral portion located at a periphery of the conductive contact portion;
temporarily fixing the safety valve and the terminal cap together by bending that part of the peripheral portion which is located outside a periphery of the flange toward the terminal cap after coupling the safety valve and the terminal cap to each other; and
conductively adhering the flange and the peripheral portion to each other near the bent portion.

11. The method of claim 9, wherein
the step of conductive adhesion is performed by welding the flange and the peripheral portion to each other.

12. The method of claim 10, wherein
the step of conductive adhesion is performed by welding the flange and the peripheral portion to each other.

13. The method of claim 11, wherein
the step of conductive adhesion is performed by welding the flange and the peripheral portion to each other by applying a laser beam mainly to either the flange or the peripheral portion depending on which is made of a material having a higher melting point.

14. The method of claim 12, wherein
the step of conductive adhesion is performed by welding the flange and the peripheral portion to each other by applying a laser beam mainly to either the flange or the peripheral portion depending on which is made of a material having a higher melting point.

15. The method of claim 11, wherein
the step of conductive adhesion is performed by welding an entire boundary between the flange and the peripheral portion, the boundary being near the bent portion.

16. The method of claim 12, wherein
the step of conductive adhesion is performed by welding an entire boundary between the flange and the peripheral portion, the boundary being near the bent portion.

17. The method of claim, 13, wherein
the step of conductive adhesion is performed by welding an entire boundary between the flange and the peripheral portion, the boundary being near the bent portion.

18. The method of claim 9, wherein
the step of conductive adhesion is performed by conductively adhering the flange and the peripheral portion to each other with a conductive adhesive agent.

19. The method of claim 10, wherein
the step of conductive adhesion is performed by conductively adhering the flange and the peripheral portion to each other with a conductive adhesive agent.

20. The method of claim 11, wherein
the outer periphery of the peripheral portion is located on an inner side of the cell than an outer side surface of the flange.

21. The method of claim 12, wherein
the outer periphery of the peripheral portion is located on an inner side of the cell than an outer side surface of the flange.

22. The method of claim 13, wherein
the outer periphery of the peripheral portion is located on an inner side of the cell than an outer side surface of the flange.

23. The method of claim 14, wherein
the outer periphery of the peripheral portion is located on an inner side of the cell than an outer side surface of the flange.

24. The method of claim 15, wherein
the outer periphery of the peripheral portion is located on an inner side of the cell than an outer side surface of the flange.

25. The method of claim 16, wherein
the outer periphery of the peripheral portion is located on an inner side of the cell than an outer side surface of the flange.

26. The method of claim 17, wherein
the outer periphery of the peripheral portion is located on an inner side of the cell than an outer side surface of the flange.

27. The method of claim 18, wherein
the outer periphery of the peripheral portion is located on an inner side of the cell than an outer side surface of the flange.

28. A sealed cell including a bottomed cylindrical outer can and a sealing body secured by caulking to an opening of the outer can so as to seal the opening,
wherein the sealing body comprises:
a terminal cap including:
an external terminal projecting toward an outside of the cell, and
a flange located at a periphery of the external terminal; and
a safety valve having a larger diameter than the terminal cap and including:
a conductive contact portion located on an inner side of the cell than the terminal cap, and projecting toward an inside of the cell, and
a peripheral portion located at a periphery of the conductive contact portion,
wherein an edge of the peripheral portion of the safety valve is bent toward the flange of the terminal cap so as to form a conductively adhered portion at a boundary between the peripheral portion and the flange, the boundary being near the edge bent.
